(19) United States
(12) Patent Application Publication
(10) Pub. No.: US 2010/0075180 A1
(43) Pub. Date: Mar. 25, 2010

(54) MAGNETIC RECORDING MEDIUM SUBSTRATE AND MANUFACTURING METHOD THEREOF, AND MAGNETIC RECORDING MEDIUM AND MANUFACTURING METHOD THEREOF

(76) Inventors: Hiroaki Ueda, Osaka (JP); Masahiro Morikawa, Tokyo (JP); Hideki Kawai, Hyogo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/445,325

(22) PCT Filed: Sep. 22, 2007
(86) PCT No.: PCT/JP2007/068471

§ 371 Date: Apr. 13, 2009

(30) Foreign Application Priority Data
Oct. 16, 2006 (JP) 2006-280979

(51) Int. Cl. G11B 5/706; B05D 5/12

(52) U.S. Cl. 428/846.9; 428/848.2; 428/846.6; 427/128

(57) ABSTRACT

Provided is a magnetic recording medium substrate suitable for preparation of a DT medium and a patterned medium, and the magnetic recording medium substrate is possible to be of easy preparation of the DT medium and the patterned medium with no complicated processes. Disclosed is a magnetic recording medium substrate comprising a circular plate-shaped substrate made of a nonmagnetic base material, wherein a predetermined region of a surface of the substrate to form a magnetic film on the surface is more roughened than another region of the surface. When forming a magnetic film on this substrate, the magnetic film is formed in the region of the substrate surface, which is more roughened than the other region, to easily prepare the DT medium and the patterned medium.

### TECHNICAL FIELD

The present invention relates to a substrate for a magnetic recording medium applied to the substrate provided in a magnetic disk recording device, and to a method of manufacturing the magnetic recording medium substrate, and the magnetic recording medium.

### BACKGROUND

There is an increasing tendency of recording capacity of a magnetic recording device such as hard disc drive device (HDD) or the like, and a perpendicular magnetic recording system is being put into practical use.

This perpendicular magnetic recording system is a recording system by which a magnetic recording medium is magnetized perpendicularly to a recording layer plane of the magnetic recording medium, and is possible to produce high-density recording. However, in the perpendicular recording system, there is a problem such that occurrence of a writing action to adjacent tracks is caused by side fringing generated from the side surface of a magnetic head in the case of a recording density of al least 100 Gbit/in², resulting in recording failure and reproducing failure.

To solve this problem, proposed is a so-called discrete track medium (hereinafter, referred to as “DT medium”), in which grooves are formed circumferentially on a magnetic recording medium to produce physical separation by forming nonmagnetic regions (non-recording regions) where no writing is made, (refer to Patent Documents 1 and 2, for example). According to this DT medium, it is possible to avoid problems such that data are written to the adjacent tracks by mistake during recording, data are read out from the adjacent tracks by mistake during reproducing, and output power reduction caused by signal noise caused by magnetic distortion at the end of a recording bit is generated, whereby avoided can be problems specific to a magnetic recording medium capable of high density recording.

Patent Document 1: Japanese Patent O.P.I. Publication No. 5-28488

Patent Document 2: Japanese Patent O.P.I. Publication No. 2005-293633

### DISCLOSURE OF THE INVENTION

### Problems to be Solved by the Invention

However, a flat plate substrate made of nonmagnetic material is utilized for a conventional DT medium, and it is desired to laminate soft magnetic layers and magnetic layers on the substrate made of nonmagnetic material, and to conduct patterning with a nanoinprint method, a photolithographic method, an electronic drawing method or the like in fabrication of a DT medium. Such the patterning processes are complicated, and produce a problem of large cost-up in the process of fabricating the magnetic recording material to form a large amount of recording capacity in the large area.

In the case of a pattering method after forming a magnetic film on a substrate made of nonmagnetic material, there is a problem such that the substrate surface is roughened, and magnetic properties are deteriorated, since clean magnetic films are processed.

This invention is to solve the above-described problems, and it is an object of the present invention to provide a magnetic recording medium substrate suitable for preparation of a DT medium and a patterned medium, and possible to be of easy preparation of the DT medium and the patterned medium with no complicated processes, and to provided a method of manufacturing the magnetic recording medium substrate, a magnetic recording medium and a method of manufacturing the magnetic recording medium.

### Means to Solve the Problems

(Structure 1) A magnetic recording medium substrate comprising a circular plate-shaped substrate made of a nonmagnetic base material, wherein a predetermined region of a surface of the substrate to form a magnetic film on the surface is more roughened than another region of the surface.

(Structure 2) The magnetic recording medium substrate of Structure 1, wherein the predetermined region has a surface roughness Ra of 4-10 nm.

(Structure 3) A magnetic recording medium substrate comprising a circular plate-shaped substrate made of a nonmagnetic base material, wherein wettability in a predetermined region of a surface of the substrate to form a magnetic film on the surface is different than in another region of the surface.

(Structure 4) A magnetic recording medium substrate comprising a circular plate-shaped substrate made of a nonmagnetic base material, wherein a composition in a predetermined region of a surface of the substrate to form a magnetic film on the surface is different than in another region of the surface.

(Structure 5) A magnetic recording medium substrate comprising a circular plate-shaped substrate made of a nonmagnetic base material, wherein a releasing agent is provided in a predetermined region of a surface of the substrate not to form a magnetic film on the surface, or in a predetermined nonmagnetic region of the surface to separate from the magnetic film.

(Structure 6) The magnetic recording medium substrate of any one of Structures 1-5, wherein the nonmagnetic base material comprises metal, metal oxide, a semiconductor, glass, ceramics, metal nitride, metal carbide or a resin.

(Structure 7) A magnetic recording medium substrate comprising a circular plate-shaped substrate made of a nonmagnetic base-material, wherein a crystal structure in a predetermined region of a surface of the substrate to form a magnetic film of the surface is different than in another region of the surface.

(Structure 8) The magnetic recording medium substrate of Structure 7, wherein the nonmagnetic base material comprises crystallized glass or a polycrystalline body.

(Structure 9) The magnetic recording medium substrate of any one of Structures 1-8, wherein the predetermined region is in the form of a point-shaped pattern, a radiation-shaped pattern, a lattice-shaped pattern, a honeycomb-shaped pattern, a dashed line-shaped pattern or a concentric circle-shaped pattern.

(Structure 10) A method of manufacturing a magnetic recording medium substrate comprising a circular plate-shaped substrate made of a nonmagnetic base material, comprising the step of conducting an acid treatment for a predetermined region of a surface of the substrate.

(Structure 11) The method of Structure 10, comprising the step of coating a releasing agent on the surface of the substrate after conducting the acid treatment.

(Structure 12) A method of manufacturing a magnetic recording medium substrate comprising a circular plate-shaped substrate made of a nonmagnetic base material, comprising the step of conducting a dry etching treatment for a predetermined region of a surface of the substrate.

(Structure 13) The method of Structure 12, comprising the step of coating a releasing agent on the surface of the substrate after conducting the dry etching treatment.

(Structure 14) A method of manufacturing a magnetic recording medium substrate comprising a circular plate-shaped substrate made of a nonmagnetic base material, comprising the step of coating a releasing agent in a predetermined region of a surface of the substrate not to form a magnetic film on the surface, or coating a releasing agent in a predetermined nonmagnetic region of a surface of the substrate to separate from the magnetic film.

(Structure 15) A method of manufacturing a magnetic recording medium substrate comprising a circular plate-shaped substrate made of a nonmagnetic base material, comprising the step of exposing a predetermined region of a surface of the substrate to UV radiation.

(Structure 16) A method of manufacturing a magnetic recording medium substrate comprising a circular plate-shaped crystallized glass substrate or a circular plate-shaped polycrystalline substrate, comprising the step of conducting a heat treatment for a predetermined region of a surface of the substrate.

(Structure 17) The method of Structure 16, comprising the step of exposing the surface of the substrate to a spot-shaped heat source to heat the predetermined region.

(Structure 18) The method of any one of Structures 10-17, wherein the predetermined region is in the form of a point-shaped pattern, a radiation-shaped pattern, a lattice-shaped pattern, a honeycomb-shaped pattern, a dashed line-shaped pattern or a concentric circle-shaped pattern.

(Structure 19) A magnetic recording medium comprising a magnetic film formed on a surface of the magnetic recording medium substrate of any one of Structures 1-9.

(Structure 20) A method of manufacturing a magnetic recording medium, comprising the step of forming a magnetic film on a surface of the magnetic recording medium substrate of any one of Structures 1-9.

(Structure 21) A magnetic recording medium comprising a magnetic film formed on a surface of the magnetic recording medium substrate prepared by the method of any one of Structures 10-18.

(Structure 22) A method of manufacturing a magnetic recording medium, comprising the step of forming a magnetic film on a surface of the magnetic recording medium substrate prepared by the method of any one of Structures 10-18.

### Effect of the Invention

The present invention enables to partially form a magnetic film, since surface roughness of the substrate surface is partially different, whereby a DT medium and a patterned medium are possible to be easily prepared.

Further, the present invention enables to partially form a magnetic film, since wettability on the substrate surface is partially different, whereby a DT medium and a patterned medium are possible to be easily prepared.

Further, the present invention enables to partially form a magnetic film, since a releasing agent is partially coated on the substrate surface is partially different, whereby a DT medium and a patterned medium are possible to be easily prepared.

Furthermore, the present invention enables to partially form a magnetic film, since a crystalline structure of the substrate surface is partially different, whereby a DT medium and a patterned medium are possible to be easily prepared.

### DESCRIPTION OF THE PREFERRED EMBODIMENTS

### The 1^{st} Embodiment

A magnetic recording medium substrate relating to the 1^{st} embodiment of the present invention and a method of manufacturing the magnetic recording medium substrate will be described.

A magnetic recording medium substrate employed in the 1^{st} embodiment possesses a circular plate-shaped substrate, and a through-hole is formed in the center of the magnetic recording medium substrate to be used as a substrate for a hard disk and so forth. This magnetic recording medium substrate is made of a nonmagnetic material, and examples of the nonmagnetic material include inorganic materials such as metal, metal oxide, a semiconductor, glass, ceramics, metal nitride, metal carbide and so forth, or resins.

In the case of the 1^{st} embodiment, a region of the substrate surface in which a magnetic layer is easy to be prepared, and another region of the substrate surface in which a magnetic layer is difficult to be prepared are formed by partially varying the surface condition of the magnetic recording medium substrate. For example, the region of the substrate surface in which a magnetic layer is easy to be prepared is formed (1) by partially varying surface roughness of the magnetic recording medium substrate, or (2) by partially varying the composition of the surface.

### <(1) Surface Roughness>

First, a method of partially varying surface roughness of a substrate will be described. For example, the surface roughness of the substrate is partially varied by patterning via nanoimprinting, and by conducting an acid treatment or a dry etching treatment for the magnetic recording medium substrate surface. The region of the substrate surface, which is subjected to an acid treatment or a dry etching treatment, is roughened. That is, the surface is relatively more roughened than that of another region by partially conducting an acid treatment or a dry etching treatment. For example, the pattern obtained via a surface treatment (a pattern in a largely roughened region of the surface) is formed as a geometric pattern capable of easy awareness and identification of position, which is typified by a point-shaped pattern (bitmap), a radiation-shaped pattern, a lattice-shaped pattern, a honeycomb-shaped pattern, a dashed line-shaped pattern, a concentric circle-shaped pattern or the like. Further, the pattern width obtained via the surface treatment is preferably 5-50 nm.

In order to conduct patterning, a resist is provided on the magnetic recording substrate and patterns are formed with respect to the resist by using a mask suitable for patterning of the magnetic film, and then an acid treatment or a dry etching treatment is conducted to vary surface roughness of the substrate. For example, a resist layer is formed in the concentric circle form at predetermined intervals, and then the region where the surface roughness is varied in the concentric circle form is formed by conducting an acid treatment or a dry etching treatment.

For example, in cases where a magnetic recording medium substrate before conducting an acid treatment or a dry etching treatment has a surface roughness Ra (JIS-B80610) of about 2 nm, surface roughness Ra is partially set to 4-10 nm by conducting the acid treatment or the dry etching treatment. That is, the surface is relatively 2-8 nm more roughened than that of another region by partially conducting the acid treatment or the dry etching treatment.

A conventional strong acid, a fluorinated acid or the like is utilized for the acid treatment. An acid concentration of 0.001-30% by weight is preferable as the whole acid, the treatment temperature is preferably 0-80° C., and the treatment time (immersion time) is preferably 0.5-1000 seconds. Suitable combinations can be selected in consideration of material properties of the magnetic recording medium substrate and the intended treatment situation among these ranges.

For example, a fluorinated acid as a principal component is preferable with respect to a glass substrate, and fluorinated ammonium, a hydrofluorosilicic acid, a hydrochloric acid, a nitric acid, a sulfuric acid or the like may be added, if desired. As to a metal substrate, an acid selected from the group consisting of a hydrochloric acid, a nitric acid and a sulfuric acid, or a mixed acid in which plural acids are mixed is preferably usable. For example, in the case of a conventional aluminum substrate as a hard disk substrate, a surface roughness Ra of 0.2-1.0 nm as a surface roughness level can be roughened by conducting a hydrochloric acid treatment at 20° C. for 10-50 seconds employing 0.1% by weight of the hydrochloric acid.

A reactive ion etching apparatus (Reactive Ion Etching: RIE) is employed for dry etching, and an RF bias of about 500 eV is applied to a substrate via introduction of fluorocarbon based gas such as CF₄ or C₄F₈ to conduct an etching treatment. Further, argon (Ar) ion milling is effective.

A region of the substrate surface which is more roughened than another region by conducting an acid treatment or a dry etching treatment is of easy magnetic film formation, or of difficult magnetic film formation. whether or not the magnetic film is formed on a region subjected to an acid treatment or a dry etching treatment depends on the material of the magnetic film and the film-forming conditions. That is, a magnetic film becomes easy to be formed or difficult to be formed on a more roughened region, depending on the material of the magnetic film and the film-forming conditions. Accordingly, by setting the pattern obtained via a surface treatment (a pattern in a largely roughened region of the surface) to a point-shaped pattern (bitmap), a radiation-shaped pattern, a lattice-shaped pattern, a honeycomb-shaped pattern, a dashed line-shaped pattern, a concentric circle-shaped pattern or the like, formed can be a magnetic film of a point-shaped pattern, a radiation-shaped pattern, a lattice-shaped pattern, a honeycomb-shaped pattern, a dashed line-shaped pattern, a concentric circle-shaped pattern or the like.

Further, one surface of the magnetic recording medium substrate as well as both surfaces of the magnetic recording medium substrate may be subjected to an acid treatment or a dry etching treatment to partially vary surface roughness of each of both substrate surfaces.

### <(2) Composition>

Next, a method of partially varying the composition of the substrate surface will be described. Also in this case, the composition of the substrate surface is partially varied by patterning via nanoimprinting, and by conducting an acid treatment or a dry etching treatment for the magnetic recording medium substrate surface. For example, the pattern obtained via a surface treatment (pattern in a region having a different composition) is set to a point-shaped pattern (bitmap), a radiation-shaped pattern, a lattice-shaped pattern, a honeycomb-shaped pattern, a dashed line-shaped pattern, a concentric circle-shaped pattern or the like. Further, the pattern width obtained via the surface treatment is preferably 5-50 nm.

Further, the substrate surface is roughened by conducting an acid treatment, but the composition of the substrate surface may be roughened without roughening the substrate surface by the condition of the acid treatment or the dry etching treatment.

An acid selected from the group consisting of a hydrochloric acid, a nitric acid, a sulfuric acid, an acetic acid, a carbonic acid, a citric acid, a formic acid, an oxalic acid and a fluorinated acid, or a mixed acid in which plural acids are mixed is preferable for an acid treatment. A utilized acid concentration of 0.0001-10% by weight is preferable as the whole acid, the treatment temperature is preferably 0-80° C., and the treatment time (immersion time) is preferably 0.5-1000 seconds. Suitable combinations can be selected in consideration of material properties of the magnetic recording medium substrate and the intended treatment situation among these ranges.

For example, when a fluorinated acid is applied to a glass substrate, a fluorinated acid treatment at a low concentration of at most 0.1% by weight is preferable. Further, as to a metal substrate, an acid selected from the group consisting of a hydrochloric acid, a nitric acid and a sulfuric acid, or a mixed acid in which plural acids are mixed is preferably usable. For example, in the case of a Ni substrate as a conventional metallic material, an oxide composition region can be patterned on the outermost substrate surface region by conducting an acid treatment with a nitric acid having a concentration of 0.001% by weight at 20° C. for 500 seconds.

Wettability on the substrate surface can be varied by conducting an acid treatment to vary the composition of the substrate surface. A region of the substrate surface in which wettability is varied is of easy magnetic film formation, or of difficult magnetic film formation. Whether or not the magnetic film is formed on a region in which wettability is varied depends on the material of the magnetic film and the film-forming conditions. That is, a magnetic film becomes easy to be formed or difficult to be formed in a region in which wettability is varied, depending on the material of the magnetic film and the film-forming conditions. Accordingly, by setting the pattern obtained via a surface treatment (pattern in a region in which a film is easy to be formed because of different wettability) to a point-shaped pattern (bitmap), a radiation-shaped pattern, a lattice-shaped pattern, a honeycomb-shaped pattern, a dashed line-shaped pattern, a concentric circle-shaped pattern or the like, formed can be a magnetic film of a point-shaped pattern, a radiation-shaped pattern, a lattice-shaped pattern, a honeycomb-shaped pattern, a dashed line-shaped pattern, a concentric circle-shaped pattern or the like.

Wettability was evaluated via measurement of water contact angle. Glass exhibiting excellent wettability had a contact angle of 5-30°. Glass exhibiting excellent water repellency had a contact angle of at least 40°.

Further, one surface of the magnetic recording medium substrate as well as both surfaces of the magnetic recording medium substrate may be subjected to an acid treatment to partially vary wettability on each of both substrate surfaces.

Next, materials usable for the magnetic recording medium substrate in the 1^{st} embodiment will be described. This magnetic recording medium substrate is made of a nonmagnetic material, and examples of the nonmagnetic material include inorganic materials such as metal, metal oxide, a semiconductor, glass, ceramics, metal nitride, metal carbide and so forth, or resins.

Aluminum, for example, is utilized as the metal. When an aluminum substrate is utilized as the magnetic recording medium substrate, after producing an aluminum plate in the form of a circular plate via press molding, the surface is subjected to a grinding/polishing process with a high degree of accuracy, and a washing process to smooth the surface.

Borosilicate glass, aluminosilicate glass or the like, for example, is usable as glass. In addition, an amorphous glass substrate, a crystallized glass substrate or chemically reinforced glass is usable as a glass substrate.

When a glass substrate is utilized as the magnetic recording medium substrate, the glass material is melted, and the melted glass is subjected to press molding to prepare a circular plate-shaped glass substrate. Then, the glass substrate surface is subjected to a grinding/polishing process with a high degree of accuracy, and a washing process to smooth the surface.

Usable examples of metal oxides include silicon oxide, zirconium oxide, aluminum oxide, titanium oxide, tantalum oxide, niobium oxide, zinc oxide, vanadium oxide, chromium oxide, manganese oxide, iron oxide, cobalt oxide, nickel oxide, copper oxide, molybdenum oxide, tin oxide, indium oxide, germanium oxide and so forth. Usable examples of semiconductors include silicon, germanium, selenium, GaAs, InSb, CdS, CdSe and so forth. Usable examples of ceramics include mullite, alumina, cordierite, zirconia, zircon, enstatite, spinel, gahnite, spodumene, cristobalite, ferrite and so forth. Usable examples of metal nitrides include aluminum nitride, gallium nitride, indium nitride, chromium nitride, silicon nitride, germanium nitride, titanium nitride, zirconium nitride, vanadium nitride and so forth.

Usable examples of metal carbides include silicon carbide (SiC), titanium carbide, zirconium carbide, niobium carbide, tantalum carbide, tungsten carbide and so forth.

Various resins other than a thermoplastic resin, a thermosetting resin and an actinic ray curable resin are usable as the resin material.

Usable examples of thermoplastic resins include polycarbonate, a polyether ether ether ketone resin (a PEEK resin), cyclic polyolefin resin, a methacryl styrene resin (an MS resin), a polystyrene resin (a PS resin), a polyether imide resin (a PEI resin), an ABS resin, a polyester resin (a PET resin, a PBT resin and so forth), a polyolefin resin (a PE resin, a PP resin and so forth), a polysulfone resin, a polyether sulfone resin (a PES resin), a polyallylate resin, a polyphenylene sulfide resin, a polyamide resin, an acrylic resin and so forth. Further, usable examples of thermosetting resins include a phenol resin, a urea resin, an unsaturated polyester resin (a BMC resin and so forth), a silicon resin, a urethane resin, an epoxy resin, a polyimide resin, a polyamideimide resin, a polybenzoimidazole resin and so forth. In addition, a polyethylene naphthalate resin (a PEN resin) and so forth can be utilized.

Further, as an actinic ray curable resin, for example, a UV curable resin is utilized. Examples of UV curable resins include a UV curable acrylurethane based resin, a UV curable polyester acrylate based resin, a UV curable epoxy acrylate based resin, a UV curable polyole acrylate based resin, a UV curable epoxy resin, a UV curable silicon based resin, a UV curable acrylic resin and so forth.

Further, when a coating layer before curing is exposed to actinic rays, and is cured, curing reaction may be accelerated by using a photoinitiator. In this case, a photosensitizer may be used in combination.

Further, in cases where oxygen in the air inhibits the above-described reaction, exposure to actinic rays can be conducted under inert gas atmosphere, for example, in order to decrease or eliminate oxygen concentration. As actinic rays, infrared rays, visible light and UV radiation can be appropriately selected, and specifically, UV radiation is preferably selected, but the present invention is not specifically limited thereto. During, before or after exposure to actinic rays, the curing reaction may also be accelerated by heating.

Further, a liquid crystal polymer, an organic/inorganic hybrid resin (for example, those incorporating silicon into a polymer component as the moiety) and so forth are usable for the magnetic recording media substrate. In addition, the resin listed above is an example of a resin utilized for the magnetic recording media substrate, and substrates employed in the present invention are not limited to these resins. At least two kinds of resins may be mixed, and different components may also be adjacently arranged for separate layers to form a substrate.

A substrate made of a resin can be prepared by a molding method such as an extrusion molding method, an injection molding method, a sheet molding method, an extrusion compression molding method, a compression molding method or the like.

Further, a resin as a base material preferably has high heat-resistant temperature or high glass transition temperature Tg as much as possible. Since a magnetic layer is formed on substrate 1 made of a resin, the heat-resistant temperature or glass transition temperature Tg is preferably higher than temperature during sputtering. For example, it is preferable to use a resin having heat-resistant temperature or glass transition temperature Tg of at least 200° C.

Examples of the typical resin having a glass transition temperature Tg of at least 200° C. include a polyether sulfone resin (a PES resin), a polyether imide resin (a PEI resin), a polyamideimide resin, a polyimide resin, a polybenzoimidazole resin, a BMC resin, a liquid crystal polymer and so forth. More specifically listed are Udel (produced by Solvay Advanced Polymers K.K.) as a polyether sulfone resin (a PES resin), Ultem (produced by Nippon GE Plastic Co. Ltd.) as a polyether imide (a PEI resin), Torlon (produced by Solvay Advanced Polymers K.K.) as a polyamideimide resin, Aurum (produced by Mitsui Chemicals, Inc.) as a polyimide resin (a thermoplastic resin), Upilex (produced by Ube Industries, Ltd.) as a polyimide (a thermosetting resin), and PBI/Celazole (produced by Client Japan) as a polybenzoimidazole resin. Further, listed are Sumica Super LCP (produced by Sumitomo Chemical Co., Ltd.) as a liquid crystal polymer, and Pictolex (produced by Pictolex MC) as polyether ether ketone.

Further, as a substrate made of a resin, a resin exhibiting less moisture absorption is preferably utilized to avoid positional displacement from a magnetic head because of dimension variation of the substrate via moisture absorption. Usable examples of the typical resin exhibiting less moisture absorption include polycarbonate and a cyclic polyolefin resin.

Further, the above explanation has been made with respect to an example in which a substrate is made of a single resin. However, the substrate is not limited to those made of a single resin, but may be formed by coating the surface of a nonmagnetic material such as metal or glass with a resin layer. In this case, usable examples of the nonmagnetic material coated by a resin include various materials applied for the substrate such as a resin, metal, ceramic, glass, glass ceramic, an organic inorganic composite material and so forth.

In cases where a magnetic recording medium is prepared employing a magnetic recording medium substrate in the 1^{st} embodiment, a magnetic layer made of a Co system alloy or the like is formed on the magnetic recording medium substrate surface via sputtering or the like to prepare a magnetic recording medium. The magnetic film is possible to be partially formed, when the magnetic recording medium substrate surface is partially roughened, or the composition of the surface is partially varied. Accordingly, by setting the pattern obtained via a surface treatment to a point-shaped pattern (bitmap), a radiation-shaped pattern, a lattice-shaped pattern, a honeycomb-shaped pattern, a dashed line-shaped pattern, a concentric circle-shaped pattern or the like, formed can be a magnetic film of a point-shaped pattern, a radiation-shaped pattern, a lattice-shaped pattern, a honeycomb-shaped pattern, a dashed line-shaped pattern, a concentric circle-shaped pattern or the like.

Further, a coating layer such as a metal layer, a ceramic layer, a magnetic layer, a glass layer, a composite later (a hybrid layer) possessing an inorganic layer and an organic layer or the like is formed on the magnetic recording medium substrate surface, and a magnetic layer may be formed on the coating layer. The coating layer preferably has a thickness of 10-300 nm.

The size of the magnetic recording medium substrate in the 1^{st} embodiment is not specifically limited. For example a 0.85 inch size substrate, a 1 inch size substrate, a 2.5 inch size substrate or a 3.5 inch size substrate may be used.

### The 2^{nd} Embodiment

A magnetic recording medium substrate relating to the 2^{nd} embodiment of the present invention and a method of manufacturing the magnetic recording medium substrate will be described.

The magnetic recording medium substrate employed in the 2^{nd} embodiment possesses the shape identical to the magnetic recording medium substrate in the 1^{st} embodiment, and utilizes the same material as that of the magnetic recording medium substrate in the 1^{st} embodiment.

In the case of the 2^{nd} embodiment, a region in which a magnetic layer is easy to be formed and another region in which a magnetic layer is difficult to be formed are formed on the substrate surface by partially coating a releasing agent on the magnetic recording medium substrate surface. Since the region on which the releasing agent is coated is of difficult magnetic film formation, it becomes possible that the magnetic film is partially formed on the substrate surface.

A perfluoroalkylsilane coupling agent, for example, can be utilized as a releasing agent, the layer thickness of the releasing film provided on the substrate surface can be controlled by changing concentration obtained via dilution employing a perfluoroalkyl based solvent. Further, after forming the releasing film, only a monomolecular layer is possible to be left over by conducting a rinsing treatment with the perfluoroalkyl based solvent.

For example, a releasing agent can be partially coated on the substrate surface via soft imprinting. In this case, the releasing agent correlating to the magnetic film pattern can be coated on the substrate by coating the releasing agent on the magnetic recording medium substrate surface employing a die suitable for the magnetic film pattern. For example, by setting the pattern obtained via coating of a releasing agent to a point-shaped pattern (bitmap), a radiation-shaped pattern, a lattice-shaped pattern, a honeycomb-shaped pattern, a dashed line-shaped pattern, a concentric circle-shaped pattern or the like, formed can be a magnetic film of a point-shaped pattern, a radiation-shaped pattern, a lattice-shaped pattern, a honeycomb-shaped pattern, a dashed line-shaped pattern, a concentric circle-shaped pattern or the like. Further, the pattern width obtained via coating of the releasing agent is preferably 5-50 nm.

Further, in accordance with desired patterns, the magnetic recording medium substrate surface is subjected to an acid treatment or an etching treatment to partially roughen the substrate surface, and subsequently, a releasing agent may be coated on the substrate surface. In this case, since a releasing agent adheres to the region in which the surface is largely roughened, the releasing agent for the desired pattern can be coated on the substrate surface.

Similarly to the 1^{st} embodiment, a magnetic layer made of a Co system alloy or the like is formed on the magnetic recording medium substrate surface in the 2^{nd} embodiment via sputtering or the like to prepare a magnetic recording medium. A releasing agent is partially coated on the magnetic recording medium substrate surface, whereby a magnetic film is possible to be partially formed.

### The 3^{rd} Embodiment

A magnetic recording medium substrate relating to the 3^{rd} embodiment of the present invention and a method of manufacturing the magnetic recording medium substrate will be described.

In the case of the 3^{rd} embodiment, the magnetic recording medium substrate surface is partially crystallized to form a region of the substrate surface in which a magnetic layer is easy to be formed, and another region of the substrate surface in which a magnetic layer is difficult to be formed. For example, partial crystallization is made (1) by partially exposing a chemical cutting glass substrate to UV radiation, or (2) by partially heating the substrate surface.

As to the depth direction of the magnetic recording medium substrate surface, crystallization may be totally made in the depth direction, or only around the surface.

### <(1) UV Exposure>

First, a method of partially exposing the substrate surface to UV radiation will be described. In this method, a chemical cutting lithium silicate type crystallized glass substrate for which Ag colloid reaction has been applied is utilized as a magnetic recording medium substrate. For example, the glass substrate surface is exposed to UV radiation by using a mask employed for desired pattern formation. Since crystallization is accelerated in the region having been exposed to UV radiation, the crystalline structure of the substrate surface can be partially varied. For example, the pattern obtained via a surface treatment (pattern in a region exposed to UV radiation) is set to a point-shaped pattern (bitmap), a radiation-shaped pattern, a lattice-shaped pattern, a honeycomb-shaped pattern, a dashed line-shaped pattern or a concentric circle-shaped pattern. In addition, the pattern width obtained via the surface treatment is preferably 5-50 nm.

An excellent pattern can be formed by exposing the substrate surface to UV pulse laser light having a wavelength of 400 nm or less with a power of 1 mW-20 W, and a pulse of 1-10000, depending on size and depth of the desired pattern.

The region in which a crystalline structure is changed via exposure to UV radiation is of easy magnetic film formation, or of difficult magnetic film formation. Whether or not the magnetic film is formed on a region exposed to UV radiation depends on the material of the magnetic film and the film-forming conditions. That is, a magnetic film becomes easy to be formed or difficult to be formed in the region exposed to UV radiation, depending on the material of the magnetic film and the film-forming conditions.

Accordingly, by setting the pattern obtained via a surface treatment (pattern in a region exposed to UV radiation) to a point-shaped pattern (bitmap), a radiation-shaped pattern, a lattice-shaped pattern, a honeycomb-shaped pattern, a dashed line-shaped pattern or a concentric circle-shaped pattern, formed can be a magnetic film of a point-shaped pattern, a radiation-shaped pattern, a lattice-shaped pattern, a honeycomb-shaped pattern, a dashed line-shaped pattern or a concentric circle-shaped pattern.

Further, not only one surface of the magnetic recording medium substrate, but also both surfaces of the magnetic recording medium substrate may be exposed to UV radiation to partially change the crystalline structure of both substrate surfaces.

### <(2) Heat Treatment>

Next, a method of partially heat-treating the substrate surface will be described. In this method, a crystallized glass substrate where crystalline particles are precipitated of the substrate surface, or a polycrystalline substrate such as ceramics or the like is employed as a magnetic recording medium substrate.

Then, a substrate such as a crystallized glass substrate or the like is exposed to a spot-shaped laser heat source having a narrowed spot of several tens of nanometers to locally heat the substrate surface, followed by rapidly cooling, and the region corresponding to the spot is changed to an amorphous structure portion. Temperature of the heat source is preferably 250-300° C. The substrate surface is exposed to the heat source spot moving along the desired pattern to form amorphous structure portions along the desired pattern on the substrate surface. For example, the pattern obtained via a surface treatment (pattern in a region exposed to a heat source) is set to a point-shaped pattern (bitmap), a radiation-shaped pattern, a lattice-shaped pattern, a honeycomb-shaped pattern, a dashed line-shaped pattern or a concentric circle-shaped pattern, formed can be a magnetic film of a point-shaped pattern, a radiation-shaped pattern, a lattice-shaped pattern, a honeycomb-shaped pattern, a dashed line-shaped pattern or a concentric circle-shaped pattern. Further, the pattern width obtained via the surface treatment is preferably 5-50 nm.

The region which has been changed to the amorphous structure portion via exposure to the heat source is of easy magnetic film formation, or of difficult magnetic film formation. Whether or not the magnetic film is formed on a region exposed to the heat source depends on the material of the magnetic film and the film-forming conditions. That is, a magnetic film becomes easy to be formed or difficult to be formed in the region exposed to the heat source, depending on the material of the magnetic film and the film-forming conditions. Accordingly, by setting the pattern obtained via a surface treatment (pattern in a region exposed to a heat source) to a point-shaped pattern (bitmap), a radiation-shaped pattern, a lattice-shaped pattern, a honeycomb-shaped pattern, a dashed line-shaped pattern, a concentric circle-shaped pattern or the like, formed can be a magnetic film of a point-shaped pattern, a radiation-shaped pattern, a lattice-shaped pattern, a honeycomb-shaped pattern, a dashed line-shaped pattern, a concentric circle-shaped pattern or the like.

Further, not only one surface of the magnetic recording medium substrate, but also both surfaces of the magnetic recording medium substrate may be exposed to the heat source to partially change the crystalline structure of both substrate surfaces.

Similarly to the 1^{st} embodiment, a magnetic layer made of a Co system alloy or the like is formed on the magnetic recording medium substrate surface in the 3^{rd} embodiment via sputtering or the like to prepare a magnetic recording medium. The crystalline structure on the magnetic recording medium substrate surface is partially changed, whereby a magnetic film is possible to be partially formed.

Accordingly, by setting the pattern obtained via a surface treatment to a point-shaped pattern (bitmap), a radiation-shaped pattern, a lattice-shaped pattern, a honeycomb-shaped pattern, a dashed line-shaped pattern or a concentric circle-shaped pattern, formed can be a magnetic film of a point-shaped pattern, a radiation-shaped pattern, a lattice-shaped pattern, a honeycomb-shaped pattern, a dashed line-shaped pattern or a concentric circle-shaped pattern.

### EXAMPLE

Next, specific examples in embodiments of the present invention will be described. Herein, the example employing a glass substrate will be described as an example of the magnetic recording medium substrate.

### Example 1

The specific example of the magnetic recording medium substrate in the above-described 1^{st} embodiment and a method thereof will be described in Example 1. Herein, a method of conducting an acid treatment in the 1^{st} embodiment will be described.

### (Glass Substrate)

The dimensions of the glass substrate employed in Example 1 are shown.

Outer diameter: 65 mm

Thickness: 0.800 mm

Surface roughness: 0.2 nm

In addition, an amorphous glass substrate composed of a borosilicate glass is used in Example 1.

### (Acid Treatment)

A resist for magnetic film patterns was formed on the above-described substrate by conducting patterning. As for the pattern shape prepared here, bits were radially arranged. The bit dimensions were set to the circle having a diameter of 100 nm, and the adjacent bit interval on the radial line being 150 nm. Then, an acid treatment was conducted. Specifically, the treatment was conducted at 30° C. for 20-100 seconds employing a treatment solution in which 0.05% by weight of fluorinated ammonium were mixed in 0.05% by weight of a hydrofluoric acid.

The above-described glass substrate was subjected to an acid treatment, and the substrate surface on which no resist was formed had a surface roughness Ra of 0.42 nm in the case of an acid treatment time of 20 seconds, had a surface roughness Ra of 0.66 nm in the case of an acid treatment time of 45 seconds, and had a surface roughness Ra of 0.98 nm in the case of an acid treatment time of 100 seconds.

### (Magnetic Film Formation)

After a FeCoZr soft magnetic layer was formed on the glass substrate surface which was subjected to an acid treatment via sputtering, a magnetic film in which SiO₂ was added into CoCrPt was formed to prepare a perpendicular magnetic recording medium.

### (Evaluation)

After forming a magnetic film on a glass substrate, the glass substrate surface was observed. It was confirmed that a magnetic region exhibiting excellent magnetic properties was formed only in the region havening been subjected to an acid treatment via film formation. A magnetic film of the desired pattern was possible to be formed on a glass substrate via a simple method to prepare a DT medium.

In addition, in the case of Example 1, the glass substrate has been employed as a magnetic recording medium substrate, but even in cases where another material provided in the 1^{st} embodiment such as metal, metal oxide, a semiconductor, glass, ceramics, metal nitride or metal carbide, for example, is employed, the same effect can be produced as that of the glass substrate by changing the conditions of the acid treatment (concentration, temperature and treatment time of the acid).

### Example 2

The specific example of the magnetic recording medium substrate in the above-described 1^{st} embodiment and a method thereof will be described in Example 2. Herein, a method of conducting a dry etching treatment in the 1^{st} embodiment will be described. The description of the dimension of the glass substrate employed in Example 2, and surface roughness Ra before conducting a dry etching treatment will be omitted since the glass substrate is the same glass substrate as in Example 1.

### (Dry Etching)

A resist for magnetic film patterns was formed on the above-described substrate by conducting patterning. The pattern prepared here was concentric circle-shaped. The circle-shaped pattern has a pattern width of 50 nm, and the interval of adjacent patterns corresponding to resist portions was set to 100 nm. Then, dry etching was conducted. As reactive gas, 40 ml of CHF₃and 2 ml of Cl₂ were introduced into an RIE apparatus to conduct an treatment for 7-15 seconds under the processing conditions of an RF power of 200 W, and a treatment pressure of 2.5 Pa.

The above-described glass substrate was subjected to a dry etching treatment, and the substrate surface on which no resist was formed had a surface roughness Ra of 4-10 nm.

### (Magnetic Film Formation)

After an underlayer was formed on the glass substrate surface which was subjected to a dry etching treatment via sputtering, a magnetic film made of a CoCrPtNb alloy was formed to prepare a magnetic recording medium.

### (Evaluation)

After forming a magnetic film on a glass substrate, the glass substrate surface was observed. It was confirmed that a magnetic region exhibiting excellent magnetic properties is formed only in the region havening been subjected to a dry etching treatment via film formation. By this, a magnetic film of the desired pattern was possible to be formed on a glass substrate via a simple method to prepare a DT medium.

In addition, in the case of Example 2, the glass substrate has been employed as a magnetic recording medium substrate, but even in cases where another material provided in the 1^{st} embodiment such as metal, metal oxide, a semiconductor, glass, ceramics, metal nitride or metal carbide, for example, is employed, the same effect can be produced as that of the glass substrate by changing the dry etching conditions.

### Example 3

The specific example of the magnetic recording medium substrate in the above-described 1^{st} embodiment and a method thereof will be described in Example 3. Herein, a method of varying the composition of the substrate surface in the 1^{st} embodiment will be described. The description of the dimension of the glass substrate employed in Example 3, and surface roughness Ra before conducting a dry etching treatment will be omitted since the glass substrate is the same glass substrate as in Example 1.

### (Acid Treatment)

A resist for magnetic film patterns was formed on the above-described substrate. As for the pattern prepared here, bits were arranged in the form of a lattice. The bit dimensions were set to a strip shape of 30×60 nm, and an adjacent bit interval of 150 nm. In the case of a soda-lime glass plate as a conventional glass substrate, the substrate was subjected to an acid treatment employing 0.5% by weight of a sulfuric acid as a treatment solution at 50° C. for 60 seconds to pattern the region of a composition having extremely small alkali component onto the outermost surface portion of the substrate.

The above-described glass substrate was subjected to an acid treatment, and only the alkali component on which no resist was formed was selectively extracted, whereby the surface composition was varied, the region exhibited excellent wettability with a contact angle of 7°. The region in which a resist was formed exhibited a contact angle of 37°, resulting in very bad wettability. In addition, wettability was evaluated with distilled water employing an automatic contact angle measuring device OCA20 manufactured by EKO INSTRUMENT CO. LTD.

### (Magnetic Film Formation)

A coating type medium made of FePt as a principal component was formed on the glass substrate surface which was subjected to an acid treatment via spin coating to prepare a magnetic recording medium.

### (Evaluation)

After forming a magnetic film on a glass substrate, the glass substrate surface was observed. It was confirmed that a magnetic film was formed in the region which was not subjected to an acid treatment. By this, a magnetic film of the desired pattern was possible to be formed on a glass substrate via a simple method to prepare a patterned medium.

In addition, in the case of Example 3, the glass substrate has been employed as a magnetic recording medium substrate, but even in cases where another material provided in the 1^{st} embodiment such as metal, metal oxide, a semiconductor, glass, ceramics, metal nitride or metal carbide, for example, is employed, the same effect can be produced as that of the glass substrate by changing the acid treatment conditions (concentration, temperature and treatment time of the acid).

### Example 4

The specific example of the magnetic recording medium substrate in the above-described 2^{nd} embodiment and a method thereof will be described in Example 4. Herein, a method of conducting a dry etching treatment in the 1^{st} embodiment will be described. The dimension and so forth of the glass substrate employed in Example 4 will be omitted since the glass substrate is the same glass substrate as in Example 1.

### (Coating of Releasing Agent)

The releasing agent employed in Example 4:

OPTOOL (produced by DAIKIN INDUSTRIES, LTD.) was utilized as a perfluoroalkylsilane coupling agent, and DEMNUM SOLVENT (produced by DAIKIN INDUSTRIES, LTD.) was utilized as a perfluoroalkyl based solvent.

Then, a releasing agent of a predetermined pattern was coated on the glass substrate via softimprinting. The pattern prepared here was designed to be a honeycomb-shaped pattern having hexagonal shapes in combination. The pattern width was 60 nm, and one side of the hexagonal shape was set to 250 nm.

### (Magnetic Film Formation)

A magnetic film made of a CoCrPt alloy was formed on the glass substrate surface which was subjected to an acid treatment via plasma CVD to prepare a magnetic recording medium.

### (Evaluation)

After forming a magnetic film on a glass substrate, the glass substrate surface was observed. It was confirmed that no magnetic film was formed in the region where a releasing agent was coated, and a magnetic film was formed in the region where a releasing agent was not coated. By this, a magnetic film of the desired pattern was possible to be formed on a glass substrate via a simple method to prepare a DT medium.

In addition, the above-described releasing agent is an example, and the same effect can be produced as above even though a triazinethiol based releasing agent or a fluorine based phosphazene compound MORESCO PHOSPHAROL (produced by Matsumura Oil Research Corporation) are specifically utilized as another releasing agent.

In addition, in the case of Example 3, the glass substrate has been employed as a magnetic recording medium substrate, but even in cases where another material provided in the embodiment such as metal, metal oxide, a semiconductor, glass, ceramics, metal nitride or metal carbide, for example, is employed, the same effect can be produced as that of the glass substrate.

### Example 5

The specific example of the magnetic recording medium substrate in the above-described 3^{rd} embodiment and a method thereof will be described in Example 5. Herein, a UV exposure method in the 3^{rd} embodiment will be described.

### (Glass Substrate)

A lithium silicate based crystallized glass obtained via Ag colloid reaction was employed in Example 5. The dimensions of this glass substrate is shown below.

Outer diameter: 38 mm

Thickness: 0.25 mm

As to a substrate material, photosensitive glass produced by SUMITA Optical Glass, Inc. was employed.

### (Exposure to UV Radiation)

The above-described glass substrate was exposed to UV radiation employing a patterned mask to crystallize the substrate surface along the pattern. The 20 nm pitched excellent pattern in which crystallization was locally accelerated was formed via 25 pulse exposure at a power of 200 mW employing KrF excimer laser having a wavelength of 248 nm. As for the pattern prepared here, bits of a square were arranged in the form of a concentric circle. The square 50 nm on a side, and an interval of concentric circles was set to 75 nm.

### (Magnetic Film Formation)

After an underlayer was formed on the glass substrate surface which was exposed to UV radiation via sputtering, a magnetic film made of a CoCrFePt alloy was formed to prepare a magnetic recording medium.

### (Evaluation)

After forming a magnetic film on a glass substrate, the glass substrate surface was observed. It was confirmed that a magnetic film was formed in the region crystallized via exposure to UV radiation. By this, a magnetic film of the desired pattern was possible to be formed on a glass substrate via a simple method to prepare a patterned medium.

### Example 6

The specific example of the magnetic recording medium substrate in the above-described 3^{rd} embodiment and a method thereof will be described in Example 6. Herein, a method of conducting a heat treatment in the 3^{rd} embodiment will be described.

### (Glass Substrate)

Crystallized glass was employed in Example 6.

Specifically, zero expansion crystallized glass ZERODUR, produced by SCHOTT AG, was employed as a substrate material.

Outer diameter: 48 mm

Thickness: 0.508 mm.

### (Heat Treatment)

An own manufactured near-field laser processing machine was used as a treatment apparatus. The opening of a near-field processing head having a diameter of 30 nm was used. GaAs surface light emitting laser having a wavelength of 850 nm as a laser light source directly installed in the head was used. Very fine spot light utilizing the plasmon effect was formed on the above-described glass substrate to provide heat in the form of a spot. Circular bits were arranged in the form of a circle through a square mask. The bit diameter was set to 65 nm, and the nit interval was set to 80 nm.

### (Magnetic Film Formation)

A magnetic film made of a CoFePt alloy was formed on the glass substrate surface which was subjected to a heat treatment via sputtering to prepare a magnetic recording medium.

### (Evaluation)

After forming a magnetic film on a glass substrate, the glass substrate surface was observed. It was confirmed that a magnetic film was formed only in the amorphous region obtained via exposure to a heat source. By this, a magnetic film of the desired pattern was possible to be formed on a glass substrate via a simple method to prepare a DT medium.

As described above, in accordance with any of Examples 1-6, it is possible to form the desired pattern on the substrate surface by partially treating the magnetic recording medium substrate surface. Thus, after forming grooves on the magnetic recording medium substrate surface, or forming a magnetic film on the glass substrate, it become possible to prepare a DT medium or a patterned medium via a simple method, since no groove has to be formed on the magnetic film.

1-22. (canceled)

23. A magnetic recording medium substrate comprising a circular plate-shaped substrate made of a nonmagnetic base material,
wherein a predetermined region of a surface of the substrate to form a magnetic film on the surface is more roughened than another region of the surface.

24. The magnetic recording medium substrate of claim 1,
wherein the predetermined region has a surface roughness Ra of 4-10 nm.

25. A magnetic recording medium substrate comprising a circular plate-shaped substrate made of a nonmagnetic base material,
wherein wettability in a predetermined region of a surface of the substrate to form a magnetic film on the surface is different than in another region of the surface.

26. A magnetic recording medium substrate comprising a circular plate-shaped substrate made of a nonmagnetic base material,
wherein a composition in a predetermined region of a surface of the substrate to form a magnetic film on the surface is different than in another region of the surface.

27. A magnetic recording medium substrate comprising a circular plate-shaped substrate made of a nonmagnetic base material,
wherein a releasing agent is provided in a predetermined region of a surface of the substrate not to form a magnetic film on the surface, or in a predetermined nonmagnetic region of the surface to separate from the magnetic film.

28. The magnetic recording medium substrate of claim 1,
wherein the nonmagnetic base material comprises metal, metal oxide, a semiconductor, glass, ceramics, metal nitride, metal carbide or a resin.

29. The magnetic recording medium substrate of claim 1,
wherein the predetermined region is in the form of a point-shaped pattern, a radiation-shaped pattern, a lattice-shaped pattern, a honeycomb-shaped pattern, a dashed line-shaped pattern or a concentric circle-shaped pattern.

30. A magnetic recording medium comprising a magnetic film formed on a surface of the magnetic recording medium substrate of claim 1.

31. A method of manufacturing a magnetic recording medium, comprising the step of:
forming a magnetic film on a surface of the magnetic recording medium substrate of claim 1.
